(19) United States
(12) Patent Application Publication
(10) Pub. No.: US 2004/0210724 A1
(43) Pub. Date: Oct. 21, 2004

(54) Block data migration

(75) Inventors: G. Paul Koning, Nashua, NH (US); Peter C. Hayden, Mount Vernon, NH (US); Paula Long, Hollis, NH (US)

Correspondence Address: ROPES & GRAY LLP, ONE INTERNATIONAL PLACE, BOSTON, MA, 02110-2624, US

(73) Assignee: EQUALLOGIC INC., Nashua, NH

(21) Appl. No.: 10/762,984

(22) Filed: Jan. 21, 2004

Related U.S. Application Data
(60) Provisional application No. 60/441,810, filed on Jan. 21, 2003.

(51) Int. Cl. G06F 12/00; G06F 13/00; G06F 9/46; G06F 15/167

(52) U.S. Cl. 711/153; 718/105; 709/215

(57) ABSTRACT

Systems for managing responses to requests from a plurality of clients for access to a set of resources and for providing a storage area network (SAN) that more efficiently responds to client load changes by migrating data blocks while providing continuous data access. In one embodiment, the systems comprise a plurality of equivalent servers wherein the set of resources is partitioned across this plurality of servers. Each equivalent server has a load monitor process that is capable of communicating with the other load monitor processes for generating a measure of the client load on the server system and the client load on each of the respective servers. The system further comprises a resource distribution process that is responsive to the measured system load and is capable of repartitioning the set of resources to thereby redistribute the client load.

### REFERENCE TO RELATED APPLICATION

This application claims priority to U.S. Provisional Application U.S. Ser. No. 60,441,810 Filed Jan. 21, 2003 and naming G. Paul Koning, among others, as an inventor, the contents of which are incorporated by reference.

### BACKGROUND

This invention relates to systems and methods for data storage in computer networks, and more particularly to systems that store data resources across a plurality of servers.

The client server architecture has been one of the more successful innovations in information technology. The client server architecture allows a plurality of clients to access services and data resources maintained and/or controlled by a server. The server listens for requests from the clients and in response to the request determines whether or not the request can be satisfied, responding to the client as appropriate. A typical example of a client server system has a “file server” set up to store data files and a number of clients that can communicate with the server. Clients typically request that the server grant access to different ones of the data files maintained by the file server. If a data file is available and a client is authorized to access that data file, the server can deliver the requested data file to the server and thereby satisfy the client's request.

Although the client server architecture has worked remarkably well, it does have some drawbacks. For example, the number of clients contacting a server and the number of requests being made by individual clients can vary significantly over time. As such, a server responding to client requests may find itself inundated with a volume of requests that is impossible or nearly impossible to satisfy. To address this problem, network administrators often make sure that the server includes sufficient data processing assets to respond to anticipated peak levels of client requests. Thus, for example, the network administrator may make sure that the server comprises a sufficient number of central processing units (CPUs) with sufficient memory and storage space to handle the volume of client traffic that may arrive.

Note that, in this disclosure, the term “resource” is to be understood to encompass, although not be limited to the files, data blocks or pages, applications, or other services or capabilities provided by the server to clients. The term “asset” is to be understood to encompass, although not be limited to the processing hardware, memory, storage devices, and other elements available to the server for the purpose of responding to client requests.

Even with a studied determination of needed system resources, variations in client load can still burden a server or group of servers acting in concert as a system. For example, even if sufficient hardware assets are provided in the server system, it may be the case that client requests focus on a particular file, data block within a file, or other resource maintained by the server. Thus, continuing with the above example, it is not uncommon that client requests overwhelmingly focus on a small portion of the data files maintained by the file server. Accordingly, even though the file server may have sufficient hardware assets to respond to a certain volume of client requests, if these requests are focused on a particular resource, such as a particular data file, most of the file server assets will remain idle while those assets that support the data file being targeted are over-burdened.

To address this problem, network engineers have developed load balancing systems that distribute client requests across the available assets for the purpose of distributing client demand on individual assets. To this end, the load balancing system may distribute client requests in a round-robin fashion that evenly distributes requests across the available server assets. In other practices, the network administrator sets up a replication system that can identify when a particular resource is the subject of a flurry of client requests and duplicate the targeted resource so that more of the server assets are employed in supporting client requests for that resource.

Furthermore, while servers do a good job of storing data, their assets are limited. One common technique employed today to extend server assets is to rely on peripheral storage devices such as tape libraries, RAID disks, and optical storage systems. When properly connected to servers, these storage devices are effective for backing up data online and storing large amounts of information. By connecting a number of such devices to a server, a network administrator can create a “server farm” (comprised of multiple server devices and attached storage devices) that can store a substantial amount of data. Such attached storage devices are collectively referred to as Network Attached Storage (NAS) systems.

But as server farms increase in size, and as companies rely more heavily on data-intensive applications such as multimedia, this traditional storage model is not quite as useful. This is because access to these peripheral devices can be slow, and it is not always possible for every user to easily and transparently access each storage device.

In order to address this shortfall, a number of vendors have been developing an architecture called a Storage Area Network (SAN). SANs provide more options for network storage, including much faster access to NAS-type peripheral devices. SANs further provide flexibility to create separate networks to handle large volumes of data.

A SAN is a high-speed special-purpose network or sub-network that interconnects different kinds of data storage devices with associated data servers on behalf of a larger network of users. Typically, a storage area network is part of the overall network of computing assets of an enterprise. SANs support disk mirroring, backup and restore, archiving, and retrieval of archived data, data migration from one storage device to another, and the sharing of data among different servers in a network. SANs can incorporate sub-networks containing NAS systems.

A SAN is usually clustered in close proximity to other computing resources (such as mainframes) but may also extend to remote locations for backup and archival storage, using wide area networking technologies such as asynchronous transfer mode (ATM) or Synchronous Optical Networks (SONET). A SAN can use existing communication technology such as optical fiber ESCON or Fibre Channel technology to connect storage peripherals and servers.

Although SANs hold much promise, they face a significant challenge. Bluntly, consumers expect a lot of their data storage systems. Specifically, consumers demand that SANs provide network-level scalability, service, and flexibility, while at the same time providing data access at speeds that compete with server farms.

This can be quite a challenge, particularly in multi-server environments, where a client wishing to access specific information or a specific file is redirected to a server that has the piece of the requested information or file. The client then establishes a new connection to the other server upon redirect and severs the connection to the originally contacted server. However, this approach defeats the benefit of maintaining a long-lived connection between the client and the initial server.

Another approach is “storage virtualization” or “storage partitioning” where an intermediary device is placed between the client and a set of physical (or even logical) servers, with the intermediary device providing request routing. None of the servers are aware that it is providing only a portion of the entire partitioned service, nor are any of the clients aware that the data resources are stored across multiple servers. Obviously, adding such an intermediary device adds complexity to the system.

Although the above techniques may work well in certain client server architectures, they each require additional devices or software (or both) disposed between the clients and the server assets to balance loads by coordinating client requests and data movement. As such, this central transaction point can act as a bottleneck that slows the server's response to client requests.

Furthermore, resources must be supplied continuously, in response to client requests, with strictly minimized latency. Accordingly, there is a need in the art for a method for rapidly distributing client load across a server system while at the same time providing suitable response times for incoming client resource requests and preserving a long-lived connection between the client and the initial server.

### SUMMARY OF THE INVENTION

The systems and methods described herein include systems for managing responses to requests from a plurality of clients for access to a set of resources. In one embodiment, the systems comprise a plurality of equivalent servers wherein the set of resources is partitioned across this plurality of servers. Each equivalent server has a load monitor process that is capable of communicating with the other load monitor processes for generating a measure of the client load on the server system and the client load on each of the respective servers. The system further comprises a resource distribution process that is responsive to the measured system load and is capable of repartitioning the set of resources to thereby redistribute the client load.

In another embodiment, the systems and methods described herein include storage area network systems (SANs) that may be employed for providing storage assets for an enterprise. The SAN of the invention comprises a plurality of servers and/or network devices. At least a portion of the servers and network devices include a load monitor process that monitors the client load being placed on the respective server or network device. The load monitor process is further capable of communicating with other load monitor processes operating on the storage area network. Each load monitor process may be capable of generating a system-wide load analysis that indicates the client load being placed on the storage area network. Additionally, the load monitor process may be capable of generating an analysis of the client load being placed on that respective server and/or network device. Based on the client load information observed by the load monitor process, the storage area network is capable of redistributing client load to achieve greater responsiveness to client requests. To this end, in one embodiment, the storage area network is capable of repartitioning the stored resources in order to redistribute client load.

### BRIEF DESCRIPTION OF THE DRAWINGS

The foregoing and other objects and advantages of the invention will be appreciated more fully from the following further description thereof, with reference to the accompanying drawings, wherein:

FIG. 1 depicts schematically the structure of a prior art system for providing access to a resource maintained on a storage area network;

FIG. 2 presents a functional block diagram of one system according to the invention;

FIG. 3 presents in more detail the system depicted in FIG. 2;

FIG. 4 is a schematic diagram of a client server architecture with servers organized in server groups;

FIG. 5 is a schematic diagram of the server groups as seen by a client;

FIG. 6 shows details of the information flow between the client and the servers of a group;

FIG. 7 is a process flow diagram for retrieving resources in a partitioned resource environment;

FIG. 8 depicts in more detail and as a functional block diagram one embodiment of a system according to the invention; and

FIG. 9 depicts an example of a routing table suitable for use with the system of FIG. 4.

The use of the same reference symbols in different drawings indicates similar or identical items.

### DETAILED DESCRIPTION OF THE ILLUSTRATED EMBODIMENTS

To provide an overall understanding of the invention, certain illustrative embodiments will now be described, including a system that provides a storage area network (SAN) that more efficiently responds to client load changes by migrating data blocks while providing continuous data access. However, it will be understood by one of ordinary skill in the art that the systems and methods described herein can be adapted and modified to redistribute resources in other applications, such as distributed file systems, database applications, and/or other applications where resources are partitioned or distributed. Moreover, such other additions and modifications fall within the scope of the invention.

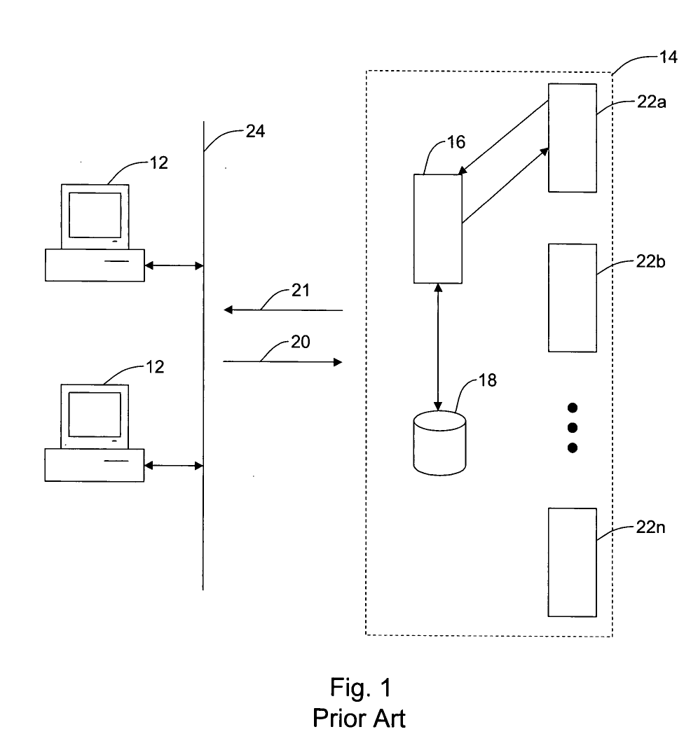

FIG. 1 depicts a prior art network system for supporting requests for resources from a plurality of clients 12 that are communicating across a local area network 24. Specifically, FIG. 1 depicts a plurality of clients 12, a local area network (LAN) 24, and a storage system 14 that includes an intermediary device 16 that processes requests from clients and passes them to servers 22. In one embodiment the intermediary device 16 is a switch. The system also includes a master data table 18, and a plurality of servers 22a-22n. The storage system 14 may provide a storage area network (SAN) that provide storage resources to the clients 12 operating across the LAN 24. As further shown in FIG. 1, each client 12 may make a request 20 for a resource maintained on the SAN 14. Each request 20 is delivered to the switch 16 and processed therein. During processing the clients 12 can request resources across the LAN 24 and the switch 16 employs the master data table 18 to identify which of the plurality of servers 22a through 22n has the resource being requested by the respective client 12.

In FIG. 1, the master data table 18 is depicted as a database system, however in alternative embodiments the switch 16 may employ a flat file master data table that is maintained by the switch 16. In either case, the switch 16 employs the master data table 18 to determine which of the servers 22a through 22n maintains which resources. Accordingly, the master data table 18 acts as an index that lists the different resources maintained by the system 14 and which of the underlying servers 22a through 22n is responsible for which of the resources.

As further depicted by FIG. 1, once the switch 16 determines the appropriate server 22a through 22n for the requested resource, the retrieved resource may be passed from the identified server through the switch 16 and back to the LAN 24 for delivery (represented by arrow 21) to the appropriate client 12. Accordingly, FIG. 1 depicts that system 14 employs the switch 16 as a central gateway through which all requests from the LAN 24 are processed. The consequence of this central gateway architecture is that delivery time of resources requested by clients 12 from system 14 can be relatively long and this delivery time may increase as latency periods grow due to increased demand for resources maintained by system 14.

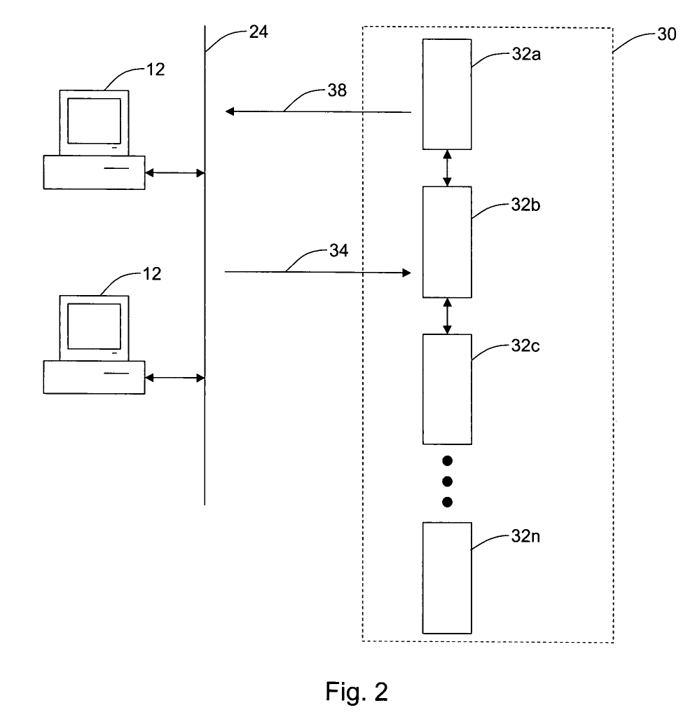

Turning to FIG. 2, a system 10 according to the invention is depicted. Specifically, FIG. 2 depicts a plurality of clients 12, a local area network (LAN) 24, and a server group 30 that includes plurality of servers 32A through 32N. As shown by FIG. 2, the clients 12 communicate across the LAN 24. As further shown in FIG. 2, each client 12 may make a request for a resource maintained by server group 30. In one application, the server group 30 is a storage area network (SAN) that provides network storage resources for clients 12. Accordingly, a client 12 may make a request across the (LAN) 24 that is transmitted, as depicted in FIG. 2 as request 34, to a server, such as the depicted server 32B of the SAN 30.

The depicted SAN 30 comprises a plurality of equivalent servers 32A through 32N. Each of these servers has a separate IP address and thus the system 10 appears as a storage area network that includes a plurality of different IP addresses, each of which may be employed by the clients 12 for accessing storage resources maintained by the SAN 30.

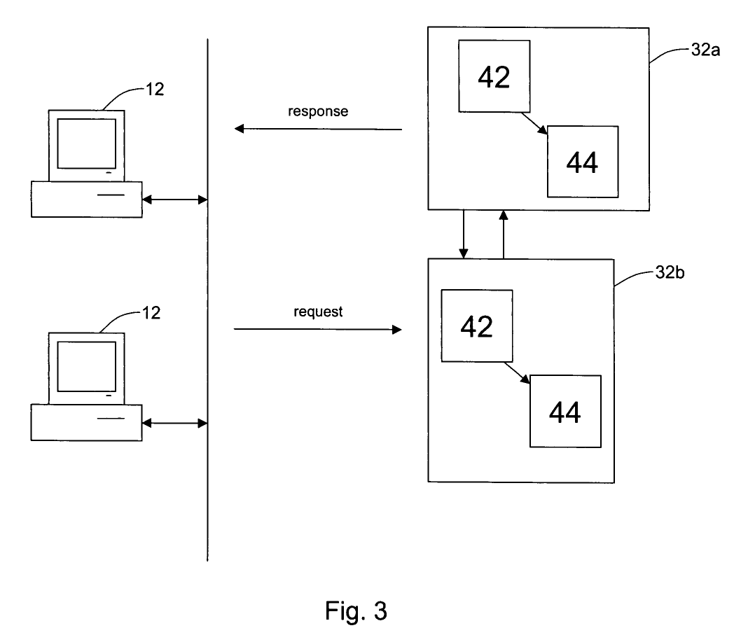

The depicted SAN 30 employs the plurality of servers 32A though 32N to partition resources across the storage area network, forming a partitioned resource set. Thus, each of the individual servers may be responsible for a portion of the resources maintained by the SAN 30. In operation, the client request 34 received by the server 32B is processed by the server 32B to determine the resource of interest to that client 12 and to determine which of the plurality of servers 32A through 32N is responsible for that particular resource. In the example depicted in FIGS. 2 and 3, the SAN 30 determines that the server 32A is responsible for the resource identified in the client request 34. As further shown by FIG. 2, the SAN 30 may optionally employ a system where, rather than have the original server 32B respond to the client request 34, a shortcut response is employed that allows the responsible server to respond directly to the requesting client 12. Server 32A thus delivers response 38 over LAN 24 to the requesting client 12.

As discussed above, the SAN 30 depicted in FIG. 2 comprises a plurality of equivalent servers. Equivalent servers will be understood, although not limited to, server systems that expose a uniform interface to a client or clients, such as the clients 12. This is illustrated in part by FIG. 3 that presents in more detail the system depicted in FIG. 2, and shows that requests from the clients 12 may be handled by the servers, which in the depicted embodiment, return a response to the appropriate client. Each equivalent server will respond in the same manner to a request presented by any client 12, and the client 12 does not need to know which one or ones of the actual servers is handling its request and generating the response. Thus, since each server 32A through 32N presents the same response to any client 12, it is immaterial to the client 12 which of the servers 32A through 32N responds to its request.

Each of the depicted servers 32A through 32N may comprise conventional computer hardware platforms such as one of the commercially available server systems from the Sun Microsystems Inc. of Santa Clara, Calif. Each server executes one or more software processes for the purpose of implementing the storage area network. The SAN 30 may employ a Fibre Channel network, an arbitrated loop, or any other type of network system suitable for providing a storage area network. As further shown in FIG. 2, each server may maintain its own storage resources or may have one or more additional storage devices coupled to it. These storage devices may include, but are not limited to, RAID systems, tape library systems, disk arrays, or any other device suitable for providing storage resources to the clients 12.

It will be understood that those of ordinary skill in the art that the systems and methods of the invention are not limited to storage area network applications and may be applied to other applications where it may be more efficient for a first server to receive a request and a second server to generate and send a response to that request. Other applications may include distributed file systems, database applications, application service provider applications, or any other application that may benefit from this technique.

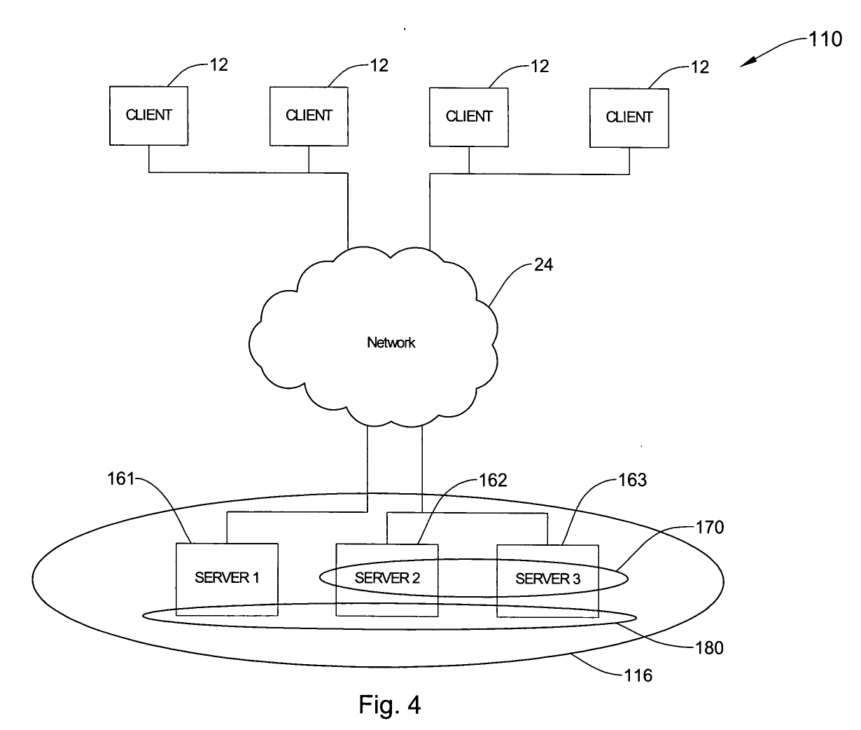

Referring now to FIG. 4, one or several clients 12 are connected, for example via a network 24, such as the Internet, an intranet, a WAN or LAN, or by direct connection, to servers 161, 162, and 163 that are part of a server group 116.

As described above, the depicted clients 12 can be any suitable computer system such as a PC workstation, a handheld computing device, a wireless communication device, or any other such device, equipped with a network client program capable of accessing and interacting with the server group 116 to exchange information with the server group 116.

Servers 161, 162 and 163 employed by the system 110 may be conventional, commercially available server hardware platforms, as described above. However any suitable data processing platform may be employed. Moreover, it will be understood that one or more of the servers 161, 162, or 163 may comprise a network storage device, such as a tape library, or other device, that is networked with the other servers and clients through network 24.

Each server 161, 162, and 163 may include software components for carrying out the operation and the transactions described herein, and the software architecture of the servers 161, 162, and 163 may vary according to the application. In certain embodiments, the servers 161, 162, and 163 may employ a software architecture that builds certain of the processes described below into the server's operating system, into device drivers, into application level programs, or into a software process that operates on a peripheral device (such as a tape library, RAID storage system, or another storage device or any combination thereof). In any case, it will be understood by those of ordinary skill in the art that the systems and methods described herein may be realized through many different embodiments and that the particular embodiment and practice employed will vary as a function of the application of interest. All these embodiments and practices accordingly fall within the scope of the present invention.

In operation, the clients 12 will have need of the resources partitioned across the server group 116. Accordingly, each of the clients 12 will send requests to the server group 116. The clients 12 typically act independently, and as such, the client load placed on the server group 116 will vary over time. In a typical operation, a client 12 will contact one of the servers, for example server 161, to access a resource, such as a data block, page (comprising a plurality of blocks), file, database table, application, or other resource. The contacted server 161 itself may not hold or have control over the requested resource. However, in a preferred embodiment, the server group 116 is configured to make all the partitioned resources available to the client 12 regardless of the server that initially receives the request. For illustration, FIG. 4 shows two resources, one resource 180 that is partitioned over all three servers (servers 161, 162, 163) and another resource 170 that is partitioned over two of the three servers. In the exemplary application of the system 110 being a block data storage system, each resource 170 and 180 may represent a partitioned block data volume.

The depicted server group 116 therefore provides a block data storage service that may operate as a storage area network (SAN) comprised of a plurality of equivalent servers, servers 161, 162, and 163. Each of the servers 161, 162, and 163 may support one or more portions of the partitioned block data volumes 170 and 180. In the depicted server group 116, there are two data resources (e.g., volumes) and three servers; however there is no specific limit on the number of servers. Similarly, there is no specific limit on the number of resources or data volumes. Moreover, each resource may be contained entirely on a single server, or it may be partitioned over several servers, either all of the servers in the server group, or a subset of the server group.

In practice, there may of course be limits due to implementation considerations, for example the amount of memory assets available in the servers 161, 162 and 163 or the computational limitations of the servers 161, 162 and 163. Moreover, the grouping. itself, i.e., deciding which servers will comprise a group, may in one practice involve an administrative decision. In a typical scenario, a group might at first contain only a few servers, perhaps only one. The system administrator would add servers to a group as needed to obtain the level of performance required. Increasing servers creates more space (memory, disk storage) for resources that are stored, more CPU processing capacity to act on the client requests, and more network capacity (network interfaces) to carry the requests and responses from and to the clients. It will be appreciated by those of skill in the art that the systems described herein are readily scaled to address increased client demands by adding additional servers into the group 116. However, as client load varies, the server group 116 can redistribute client load to take better advantage of the available assets in server group 116.

To this end, the server group 116, in one embodiment, comprises a plurality of equivalent servers. Each equivalent server supports a portion of the resources partitioned over the server group 116. As client requests are delivered to the equivalent servers, the equivalent servers coordinate among themselves to generate a measure of system load and to generate a measure of the client load of each of the equivalent servers. In a preferred practice, this coordinating is transparent to the clients 12, and the servers can distribute the load among each other without causing the clients to alternate or change the way they access a resource.

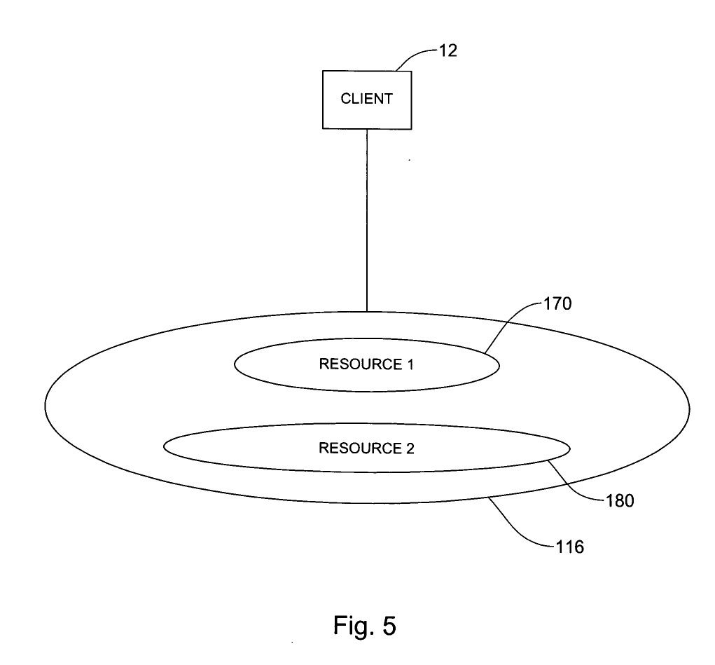

Referring now to FIG. 5, a client 12 connecting to a server 161 (FIG. 4) will see the server group 116 as if the group were a single server having multiple IP addresses. The client 12 is not necessarily aware that the server group 116 is constructed out of a potentially large number of servers 161, 162, 163, nor is it aware of the partitioning of the block data volumes 170 and 180 over the several servers. A particular client 12 may have access to only a single server, through its unique IP address. As a result, the number of servers and the manner in which resources are partitioned among the servers may be changed without affecting the network environment seen by the client 12.

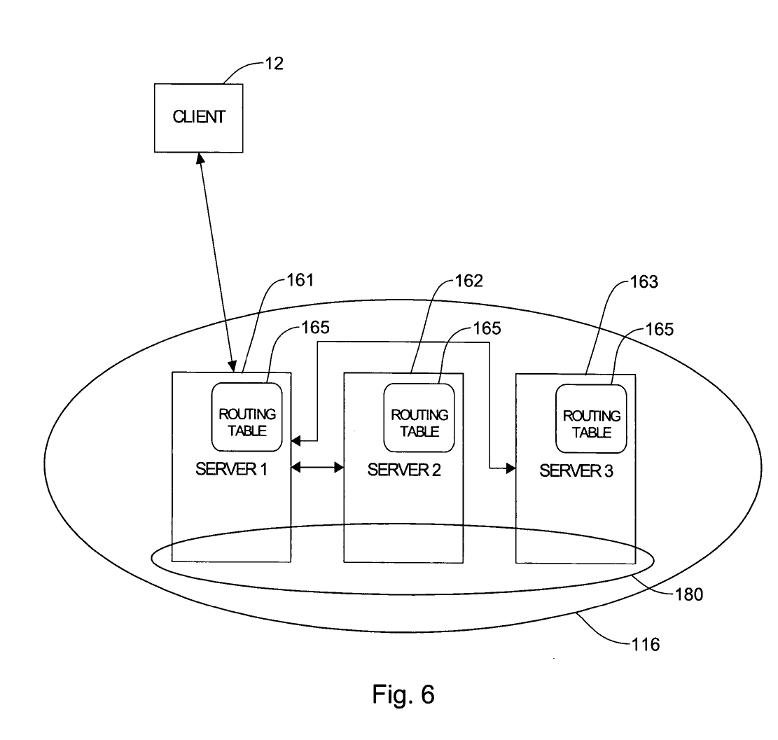

FIG. 6 shows the resource 180 of FIG. 5 as being partitioned across servers 161, 162 and 163. In the partitioned server group 116, any data volume may be spread over any number of servers within the server group 116. As seen in FIGS. 4 and 5, one volume 170 (Resource 1) may be spread over servers 162, 163, whereas another volume 180 (Resource 2) may be spread over servers 161, 162, 163. Advantageously, the respective volumes may be arranged in fixed-size groups of blocks, also referred to as “pages,” wherein an exemplary page contains 8192 blocks. Other suitable page sizes may be employed, and pages comprising variable numbers of blocks (rather than fixed) are also possible.

In an exemplary embodiment, each server in the group 116 contains a routing table 165 for each volume, with the routing table 165 identifying the server on which a specific page of a specific volume can be found. For example, when the server 161 receives a request from a client 12 for volume 3, block 93847, the server 161 calculates the page number (page 11 in this example for the page size of 8192) and looks up in the routing table 165 the location or number of the server that contains page 11. If server 163 contains page 11, the request is forwarded to server 163, which reads the data and returns the data to the server 161. Server 161 then sends the requested data to the client 12. The response may be returned to the client 12 via the same server 161 that received the request from the client 12. Alternatively, the short-cut approach described above may be used.

Accordingly, it is immaterial to the client 12 as to which server 161, 162, 163 has the resource of interest to the client 12 . As described above, the servers 162, 162 and 163 will employ the routing tables to service the client request, and the client 12 need not know ahead of time which server is associated with the requested resource. This allows portions of the resource to exist at different servers. It also allows resources, or portions thereof, to be moved while the client 12 is connected to the partitioned server group 116. This latter type of resource re-partitioning is referred to herein as “block data migration” in the case of moving parts of resources consisting of data blocks or pages. One of ordinary skill in the art will of course see that resource parts consisting of other types of resources (discussed elsewhere in this disclosure) may also be moved by similar means. Accordingly, the invention is not limited to any particular type of resource.

Data may be moved upon command of an administrator or automatically by storage load balancing mechanisms such as those discussed herein. Typically, such movement or migration of data resources is done in groups of blocks referred to as pages.

When a page is moved from one equivalent server to another, it is important for all of the data, including that in the page being moved, to be continuously accessible to the clients so as not to introduce or increase response time latency. In the case of manual moves, as implemented in some servers seen today, the manual migration interrupts service to the clients. As this is generally considered unacceptable, automatic moves that do not result in service interruptions are preferable. In such automatic migrations, the movement must needs be transparent to the clients.

According to one embodiment of the present invention, a page to be migrated is considered initially “owned” by the originating server (i.e., the server on which the data is initially stored) while the move is in progress. Routing of client read requests continue to go through this originating server.

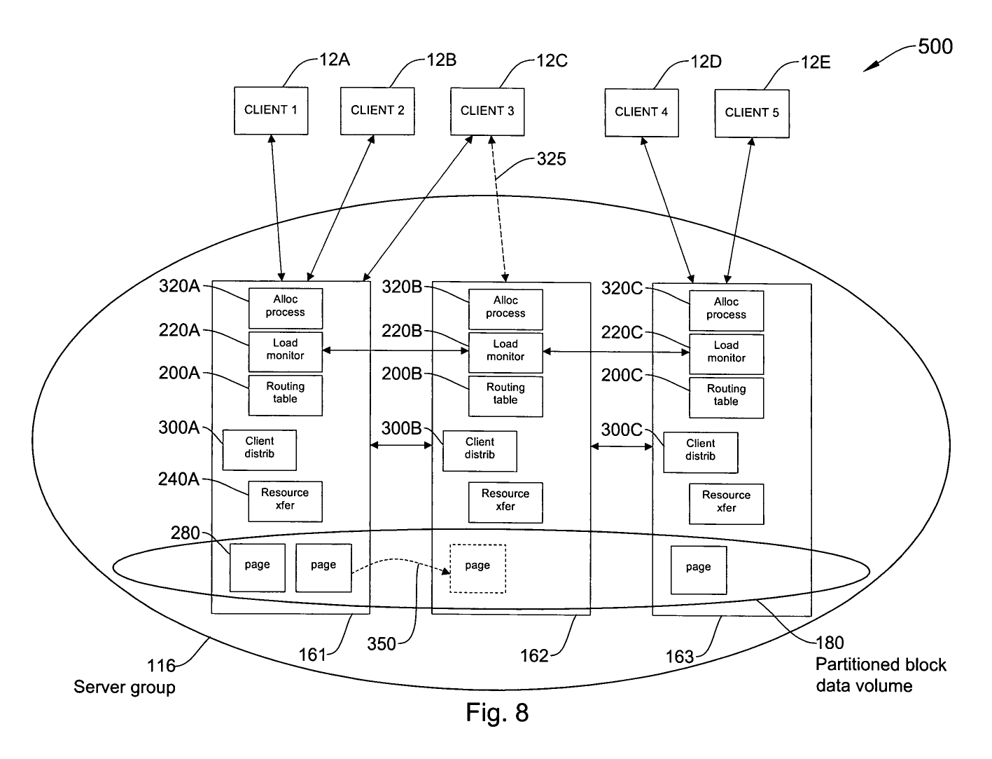

Requests to write new data into the target page are handled specially: data is written to both the page location at the originating server and to the new (copy) page location at the destination server. In this way, a consistent image of the page will end up at the destination server even if multiple write requests are processed during the move. In one embodiment, it is the resource transfer process 240 depicted in FIG. 8 that carries out this operation. A more elaborate approach may be used when pages become large. In such cases, the migration may be done in pieces: a write to a piece that has already been moved is simply redirected to the destination server; a write to a piece currently being moved goes to both servers as before. Obviously, a write to a piece not yet moved may be processed by the originating server.

Such write processing approaches are necessary to support the actions required if a failure should occur during the move, such as a power outage. If the page is moved as a single unit, an aborted (failed) write can begin over again from the beginning. If the page is moved in pieces, the move can be restarted from the piece that was in transit at the failure. It is the possibility of restart that makes it necessary to write data to both the originating and destination servers.

Table 1 shows the sequence of block data migration stages for a unit block data move from a server A to Server B; Table 2 shows the same information for a piece-wise block data move.

TABLE 1

| | Restart | | | | |
|---|---|---|---|---|---|
| Stage | Stage | Destination | Action | Read | Write |
| 1 | N/A | Server A | Not started | Server A | Server A |
| 2 | 2 | Server A | Start move | Server A | Servers A |
| | | | | | and B |
| 3 | 2 | Server A | Finish Move | Server A | Servers |
| | | | | | A and B |
| 4 | N/A | Server B | Routing | Server B | Server B |
| | | | Table | | |
| | | | updated | | |

TABLE 2

| | Restart | | | | |
|---|---|---|---|---|---|
| Stage | Stage | Destination | Action | Read | Write |
| 1 | N/A | Server A | Not started | Server A | Server A |
| 2 | 2 | | Start move, | Server A | Servers A and B for |
| | | | piece 1 | | piece 1, server A |
| | | | | | for others |
| 3 | 2 | Server A | Finish move, | Server B for piece | Server B for piece |
| | | | piece 1 | 1, server A for | 1, server A for |
| | | | | others | others |
| 4 | 4 | | Start move, | Server B for piece | Server B for piece |
| | | | piece 2 | 1, server A for | 1, servers A and B |
| | | | | others | for piece 2, server |
| | | | | | A for others |
| 5 | 4 | | Finish move, | Server B for pieces | Server B for pieces |
| | | | piece 2 | 1 and 2, server A | 1 and 2, server A |
| | | | | for others | for others |
| . . . | (repeat as needed for all pieces) | | | | |
| n | N/A | Server B | Routing | Server B | Server B |
| | | | Table | | |
| | | | updated | | |

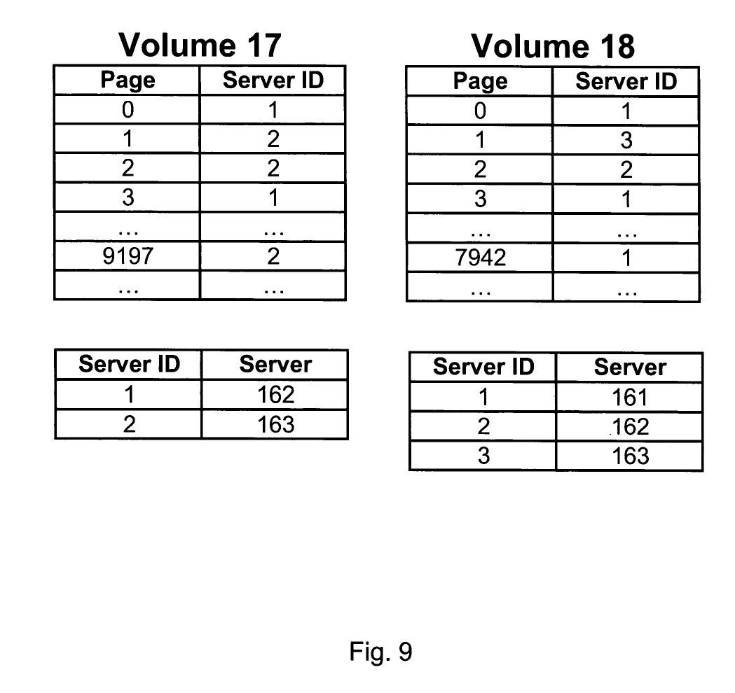

Upon moving a resource, the routing tables 165 (referring again to FIG. 9) are updated as necessary (through means well-known in the art) and subsequent client requests will be forwarded to the server now responsible for handling that request. Note that, at least among servers containing the same resource 170 or 180, the routing tables 165 may be identical subject to propagation delays.

In some embodiments, once the routing tables are updated, the page at the originating server (or “source” resource) is deleted by standard means. Additionally, a flag or other marker is set in the originating server for the originating page location to denote, at least temporarily, that that data is no longer valid. Any latent read or write requests still destined for the originating server will thus trigger an error and subsequent retry, rather than reading the expired data on that server. By the time any such retries return, they will encounter the updated routing tables and be appropriately directed to the destination server. In no case are duplicated, replicated, or shadowed copies of the block data (as those terms are known in the art) left on in the server group. Optionally, in other embodiments the originating server may retain a pointer or other indicator to the destination server. The originating server may, for some selected period of time, forward requests, including but not being limited to, read and write requests, to the destination server. In this optional embodiment, the client 12 does not receive an error when the requests are latest or arrive at the originating server because some of the routing tables in the group have not yet been updated. Requests can be handled at both the originating server and the destination server. This lazy updating process eliminates or reduces the need to synchronize the processing of client requests with routing table updates. The routing table updates occur in the background.

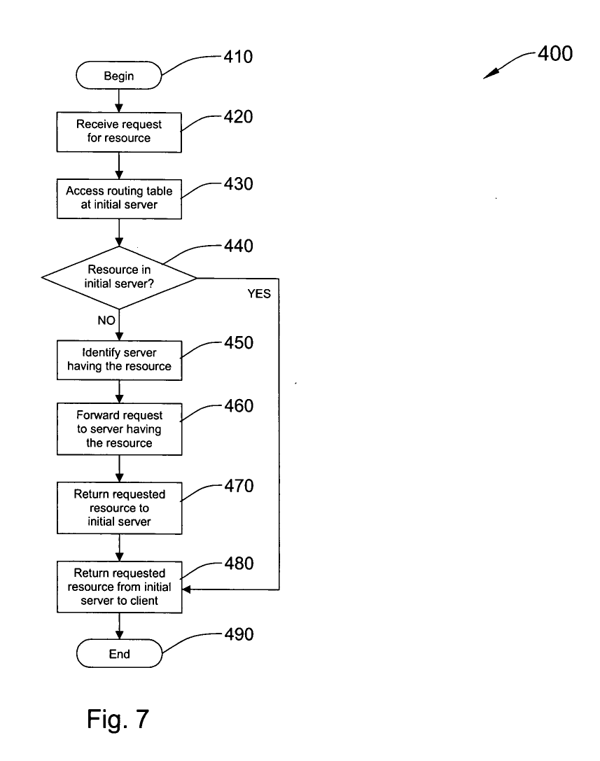

FIG. 7 depicts an exemplary request handling process 400 for handling client requests in a partitioned server environment. The request handling process 400 begins at 410 by receiving a request for a resource, such as a file or blocks of a file, at 420. The request handling process 400 examines the routing table, in operation 430, to determine at which server the requested resource is located. If the requested resource is present at the initial server, the initial server returns the requested resource to the client 12, at 480, and the process 400 terminates at 490. Conversely, if the requested resource is not present at the initial server, the server will use the data from the routing table to determine which server actually holds the resource requested by the client, operation 450. The request is then forwarded to the server that holds the requested resource, operation 460, which returns the requested resource to the initial server, operation 480. The process 400 then goes to 480 as before, to have the initial server forward the requested resource to the client 12, and the process 400 terminates, at 490.

Accordingly, one of ordinary skill in the act will see that the system and methods described herein are capable of migrating one or more partitioned resources over a plurality of servers, thereby providing a server group capable of handling requests from multiple clients. The resources so migrated over the several servers can be directories, individual files within a directory, blocks within a file or any combination thereof. Other partitioned services may be realized. For example, it may be possible to partition a database in an analogous fashion or to provide a distributed file system, or a distributed or partitioned server that supports applications being delivered over the Internet. In general, the approach can be applied to any service where a client request can be interpreted as a request for a piece of the total resource.

Turning now to FIG. 8, one particular embodiment of the system 500 is depicted wherein the system is capable of redistributing client load to provide more efficient service. Specifically, FIG. 8 depicts a system 500 wherein the clients 12A through 12E communicate with the server block 116. The server block 116 includes three equivalent servers, server 161, 162, and 163, in that each of the servers will provide substantially the same response to the same request from a client. Typically, it will produce the identical response, subject to differences arising due to propagation delay or response timing. As such, from the perspective of the clients 12, the server group 116 appears to be a single server system that provides multiple network or IP addresses for communicating with clients 12A-12E.

Each server includes a routing table, depicted as routing tables 200A, 200B and 200C, a load monitor process 220A, 220B and 220C respectively, a client allocation process 320A, 320B, and 320C, a client distribution process 300A, 300B and 300C and a resource transfer process, 240A, 240B and 240C respectively. Further, and for the purpose of illustration only, the FIG. 8 represents the resources as pages of data 280 that may be transferred from one server to another server.

As shown by arrows in FIG. 8, each of the routing tables 200A, 200B, and 200C are capable of communicating with each other for the purpose of sharing information. As described above, the routing tables may track which of the individual equivalent servers is responsible for a particular resource maintained by the server group 116. Because each of the equivalent servers 161, 162 and 163 are capable of providing the same response to the same request from a client 12, routing tables 200A, 200B, and 200C (respectively) coordinate with each other to provide a global database of the different resources and the specific equivalent servers that are responsible for those resources.

FIG. 9 depicts one example of a routing table 200A and the information stored therein. As depicted in FIG. 9, each routing table includes an identifier for each of the equivalent servers 161, 162 and 163 that support the partitioned data block storage group 116. Additionally, each of the routing tables includes a table that identifies those data blocks associated with each of the respective equivalent servers. In the routing table embodiment depicted by FIG. 9, the equivalent servers support two partitioned volumes. A first one of the volumes is distributed or partitioned across all three equivalent servers 161, 162, and 163. The second partitioned volume is partitioned across two of the equivalent servers, servers 162 and 163 respectively.

In operation, each of the depicted servers 161, 162, and 163 is capable of monitoring the complete load that is placed on the server group 116 as well as the load from each client and the individual client load that is being handled by each of the respective servers 161, 162 and 163. To this end, each of the servers 161, 162 and 163 include a load monitoring process 220A, 220B, and 220C respectively. As described above, the load monitor processes 220A, 220B and 220C are capable of communicating among each other. This is illustrated in FIG. 8 by the bidirectional lines that couple the load monitor processes on the different servers 161, 162 and 163.

Each of the depicted load monitor processes may be software processes executing on the respective servers and monitoring the client requests being handled by the respective server. The load monitors may monitor the number of individual clients 12 being handled by the respective server, the number of requests being handled by each and all of the clients 12, and/or other information such as the data access patterns (predominantly sequential data access, predominantly random data access, or neither).

Accordingly, the load monitor process 220A is capable of generating information representative of the client load applied to the server 161 and is capable of corresponding with the load monitor 220B of server 162. In turn, the load monitor process 220B of server 162 may communicate with the load monitor process 220C of server 163, and load monitor process 220C may communicate with process 220A (not shown). By allowing for communication between the different load monitor processes 220A, 220B, and 220C, the load monitor processes may determine the system-wide load applied to the server group 116 by the clients 12.

In this example, the client 12C may be continually requesting access to the same resource. For example, such a resource may be the page 280, maintained by the server 161. That load in addition to all the other requests may be such that server 161 is carrying an excessive fraction of the total system traffic, while server 162 is carrying less than the expected fraction. Therefore the load monitoring and resource allocation processes conclude that the page 280 should be moved to server 162, and the client distribution process 300A can activate the block data migration process 350 (described above) that transfers page 280 from server 161 to server 162. Accordingly, in the embodiment depicted in FIG. 8 the client distribution process 300A cooperates with the resource transfer process 240A to re-partition the resources in a manner that is more likely to cause client 12C to continually make requests to server 162 as opposed to server 161.

Once the resource 280 has been transferred to server 162, the routing table 200B can update itself (by standard means well-known in the art) and update the routing tables 200A and 200C accordingly, again by standard means well-known in the art. In this way, the resources may be repartitioned across the servers 161, 162 and 163 in a manner that redistribute client load as well.

Alternate Embodiments

The order in which the steps of the present method are performed is purely illustrative in nature. In fact, the steps can be performed in any order or in parallel, unless otherwise indicated by the present disclosure.

The method of the present invention may be performed in either hardware, software, or any combination thereof, as those terms are currently known in the art. In particular, the present method may be carried out by software, firmware, or microcode operating on a computer or computers of any type. Additionally, software embodying the present invention may comprise computer instructions in any form (e.g., source code, object code, interpreted code, etc.) stored in any computer-readable medium (e.g., ROM, RAM, magnetic media, punched tape or card, compact disc (CD) in any form, DVD, etc.). Furthermore, such software may also be in the form of a computer data signal embodied in a carrier wave, such as that found within the well-known Web pages transferred among devices connected to the Internet. Accordingly, the present invention is not limited to any particular platform, unless specifically stated otherwise in the present disclosure.

Moreover, the depicted system and methods may be constructed from conventional hardware systems and specially developed hardware is not necessary. For example, in the depicted systems, the clients can be any suitable computer system such as a PC workstation, a handheld computing device, a wireless communication device, or any other such device equipped with a network client hardware and or software capable of accessing a network server and interacting with the server to exchange information. Optionally, the client and the server may rely on an unsecured communication path for accessing services on the remote server. To add security to such a communication path, the client and the server can employ a security system, such the Secured Socket Layer (SSL) security mechanism, which provides a trusted path between a client and a server. Alternatively, they may employ another conventional security system that has been developed to provide to the remote user a secured channel for transmitting data over a network.

Furthermore, networks employed in the systems herein disclosed may include conventional and unconventional computer to computer communications systems now known or engineered in the future, such as but not limited to the Internet.

Servers may be supported by a commercially available server platform such as a Sun Microsystems, Inc. Sparc™ system running a version of the UNIX operating system and running a server program capable of connecting with, or exchanging data with, clients.

Those skilled in the art will know, or be able to ascertain using no more than routine experimentation, many equivalents to the embodiments and practices described herein. For example, the processing or I/O capabilities of the servers 161, 162, 163 may not be the same, and the allocation process 220 will take this into account when making resource migration decisions. In addition, there may be several parameters that together constitute the measure of “load” in a system-network traffic, I/O request rates, as well as data access patterns (for example, whether the accesses are predominantly sequential or predominantly random). The allocation process 220 will take all these parameters into account as input to its migration decisions.

As discussed above, the invention disclosed herein can be realized as a software component operating on a conventional data processing system such as a UNIX workstation. In that embodiment, the short cut response mechanism can be implemented as a C language computer program, or a computer program written in any high level language including C++, C#, Pascal, FORTRAN, Java, or BASIC. Additionally, in an embodiment where microcontrollers or digital signal processors (DSPs) are employed, the short cut response mechanism can be realized as a computer program written in microcode or written in a high level language and compiled down to microcode that can be executed on the platform employed. The development of such code is known to those of skill in the art, and such techniques are set forth in Digital Signal Processing Applications with the TMS320 Family, Volumes I, II, and III, Texas Instruments (1990). Additionally, general techniques for high level programming are known, and set forth in, for example, Stephen G. Kochan, Programming in C, Hayden Publishing (1983).

While particular embodiments of the present invention have been shown and described, it will be apparent to those skilled in the art that changes and modifications may be made without departing from this invention in its broader aspect and, therefore, the appended claims are to encompass within their scope all such changes and modifications as fall within the true spirit of this invention.

We claim:

1. An apparatus for resource migration, comprising a storage system having
a plurality of storage servers with a set of resources partitioned thereon, said storage servers having a load monitor process capable of communicating with other load monitor processes for generating a measure of loading on respective ones of the plurality of servers;
a resource migration process for transferring a resource from one of said plurality of servers to another of said plurality of servers in response to said measure of loading.

2. The apparatus of claim 1, wherein said servers are equivalent to each other.

3. The apparatus of claim 1, wherein said resources are selected from the group consisting of data blocks, program files, multimedia files, applications, and database files.

4. The apparatus of claim 1, wherein said measure of loading reflects both a storage system load and a server load.

5. The apparatus of claim 1, wherein said storage system is a Storage Area Network.

6. The apparatus of claim 1, wherein the load monitor includes a process to determine whether a server is servicing a disproportionate share of the client requests being handled by a server group.

7. The apparatus of claim 1, wherein the resource migration process includes a block data migration process.

8. The apparatus of claim 1, further including a routing table for tracking resources maintained on the system.

9. The apparatus of claim 1, wherein a pointer to a resource is maintained during a an access operation to provide continuous data access.

10. The apparatus of claim 1, wherein the load monitoring process monitors one or more of network traffic load, I/O request load, storage traffic pattern type.

11. The apparatus of claim 1, wherein the resource migration process includes a further process to detect when a resource write request applies to a resource that is in the process of being moved from a first server to a second server, and apply such resource write request to both copies of the resource held at said first and said second server.

12. The apparatus of claim 1, wherein the resource migration process divides the resource being moved into smaller subresources, such that each subresource is moved from a first server to a second server in turn, and recovery from failure requires only the recovery of the subresource being moved at the time of failure and subsequent subresources.

13. The apparatus of claim 12, wherein the resource migration process includes a further process to detect when a resource write request applies to a subresource that is in the process of being moved from a first server to a second server, and apply such resource write request to both copies of the resource held at said first and said second server.

14. A process for moving resources across a storage system having
a plurality of storage servers with a set of resources partitioned thereon, comprising the steps of
monitoring a load on a server and communicating with other load monitor processes for generating a measure of loading on respective ones of the plurality of servers; and
transferring, as a function of the measured loads, a resource from one of said plurality of servers to another of said plurality of servers in response to said measure of loading.

15. The process of claim 14, wherein said servers are equivalent to each other.

16. The process of claim 14, measuring a load includes measuring a storage system load and a server load.

17. The process of claim 14, including the further step determining whether a server is servicing a disproportionate share of the client requests being handled by a server group.

18. The process of claim 14, wherein the resource migration process includes a block data migration process.

19. The process of claim 14, further including maintaining a routing table for tracking resources maintained on the system.

20. The process of claim 14, wherein the load monitoring process monitors one or more of network traffic load, I/O request load, storage traffic pattern type.

21. The process of claim 14, further including maintaining a pointer to a resource is maintained during an access operation to provide continuous data access.

22. The process of claim 14, further including detecting when a resource write request applies to a resource that is in the process of being moved from a first server to a second server, and applying such resource write request to both copies of the resource held at said first and said second server.

23. The process of claim 14, further including dividing the resource being moved into smaller subresources, such that each subresource is moved from a first server to a second server in turn, and recovery from failure requires only the recovery of the subresource being moved at the time of failure and subsequent subresources.

24. The process of claim 23, further including detecting when a resource write request applies to a subresource that is in the process of being moved from a first server to a second server, and apply such resource write request to both copies of the resource held at said first and said second server. server to a second server, and apply such resource write request to both copies of the resource held at said first and said second server.
